(19) United States
(12) Patent Application Publication
(10) Pub. No.: US 2015/0152997 A1
(43) Pub. Date: Jun. 4, 2015

(54) ROTATABLE ASSEMBLY

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: SI-JING YANG, Shenzhen (CN); WEI-DONG SONG, Shenzhen (CN)

(21) Appl. No.: 14/497,997

(22) Filed: Sep. 26, 2014

(30) Foreign Application Priority Data
Nov. 30, 2013 (CN) 2013106219643

(51) Int. Cl. F16M 11/18

(52) U.S. Cl. CPC F16M 11/18

(57) ABSTRACT

A rotatable assembly includes a base, a supporting member, a sliding member, and a rotatable member. The supporting member substantially perpendicularly protrudes from the base. The sliding member includes a sliding bar and a rack. The sliding bar is slidably connected to the base and passes through the supporting member. The rack is fixed to the surface of the sliding bar. The rotatable member includes a gear, a shaft, and a platform. The gear engages with the rack. The shaft passes through the supporting member to rotatably connect to the supporting member. The shaft is fixed in a hollow of the gear and is fixed to the platform. The platform arranges an electronic device thereon.

### CROSS-REFERENCE TO RELATED APPLICATIONS

This application claims priority to Chinese Patent Application No. 201310621964.3 filed on Nov. 30, 2013, the contents of which are incorporated by reference herein.

### FIELD

The subject matter herein generally relates to rotatable assemblies, and particularly, to a rotatable assembly capable of bringing an electronic device placed thereon to rotate.

### BACKGROUND

During assembling, some electronic devices need to be rotated to a desired position to process.

### BRIEF DESCRIPTION OF THE DRAWINGS

Implementations of the present technology will now be described, by way of example only, with reference to the attached figures.

FIG. 1 is an isometric view showing an embodiment of a rotatable assembly.

FIG. 2 is similar to FIG. 1, but viewed from another angle.

FIG. 3 is an exploded, isometric view showing the rotatable assembly of FIG. 1.

FIG. 4 is similar to FIG. 2, but omitting a portion of the rotatable assembly to show the engagement of a gear and a rack.

FIG. 5 is an enlarged, isometric view of the circled portion V of FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

Embodiments of the present disclosure will be described with reference to the accompanying drawings.

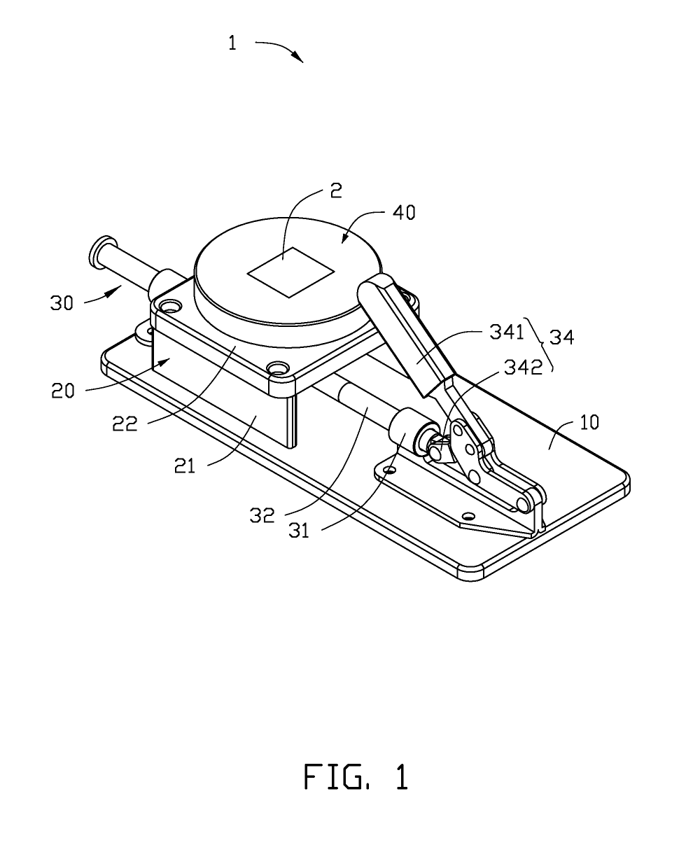

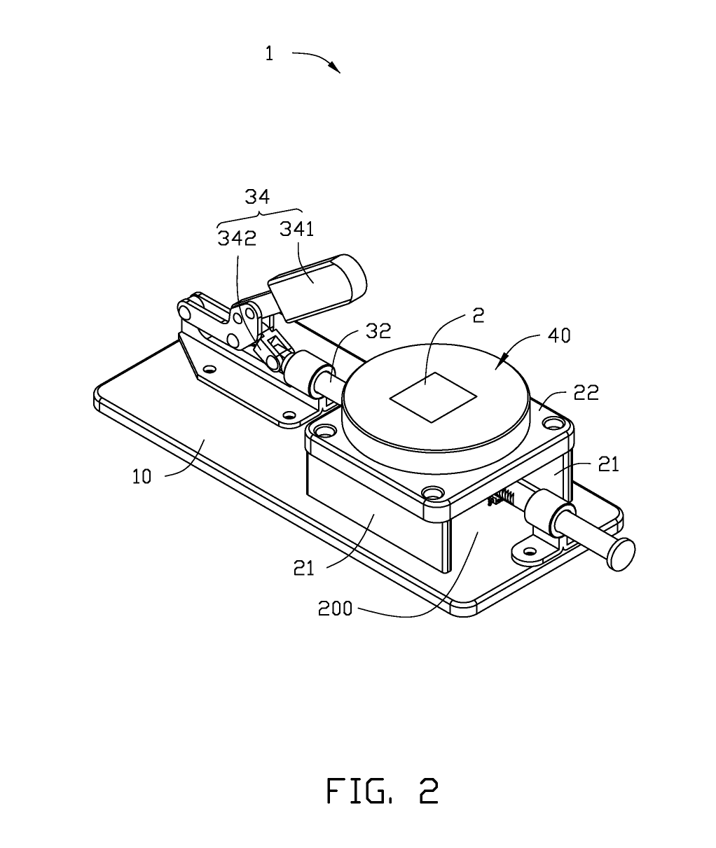

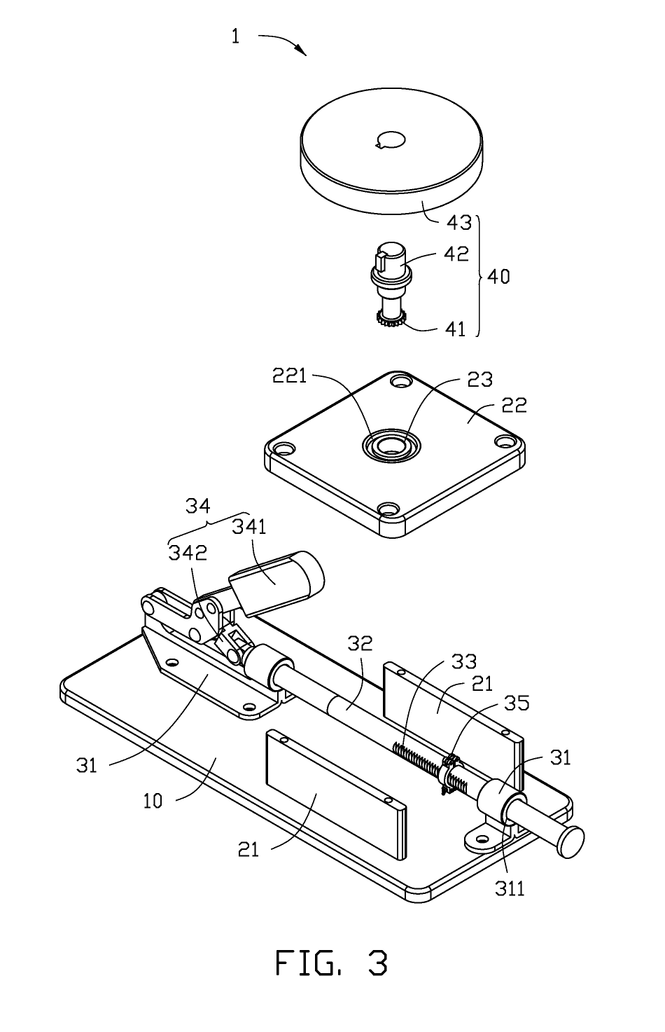

FIGS. 1-3 illustrate an embodiment of a rotatable assembly 1. The rotatable assembly 1 can include a base 10, a supporting member 20, a sliding member 30, and a rotatable member 40.

The supporting member 20 can include two supporting plates 21, a top plate 22, and a bearing 23. The two supporting plates 21 can substantially perpendicularly protrude from the base 10 and can be spaced from each other. The top plate 22 can be fixed to one supporting plate, extend from the one supporting plate to the other supporting plate, and be fixed to the other supporting plate. The top plate 22, the supporting plates 21, and the base 10 can cooperatively form a receiving room 220. The top plate 22 can define a first through hole 221 from an upper surface to a lower surface. The bearing 23 can be fixed in the first through hole 221 of the top plate 22.

The sliding member 30 can be slidably connected to the base 10. In the embodiment, the sliding member 30 can include two limiting members 31, a sliding bar 32, a rack 33, and an operating member 34. The two limiting members 31 can be fixed to the base 10 and can be spaced from each other. Each limiting member 31 can define a second through hole 311. The sliding bar 32 can pass through the second through hole 311 of each limiting member 31 and extend through the receiving room 220. The rack 33 can be fixed to the peripheral surface of the sliding bar 32 and extend along the length of the sliding bar 32. The operating member 34 can be movably connected to the base 10. The operating member 34 can exert a pull/push force to the sliding bar 32 to cause the sliding bar 32 to slide with respect to the base 10.

The rotatable member 40 can include a gear 41, a shaft 42, and a platform 43. The gear 41 can engage with the rack 33. The bottom of the shaft 42 can be fixed in a hollow of the gear 41. The shaft 42 can pass through a hollow of the bearing 23 to rotatably connect to the top plate 22. The platform 43 can be fixed to a top of the shaft 42. An electronic device 2 can be placed on the platform 43.

When rotating the electronic device 2, the operating member 34 is operated to pull/push the sliding bar 32 to slide, the sliding bar 32 can bring the rack 33 to slide, the gear 41 can engage with the rack 33 to rotate the shaft 42, the platform 43 can rotate together with the shaft 42, causing the electronic device 2 placed on the platform 43 to rotate.

In the embodiment, the operating member 34 can include a handle 341 and a connecting member 342. The handle 341 can be rotatably connected to one of the limiting members 31. A first end of the connecting member 342 can be rotatably connected to the handle 341 and a second end of the connecting member 342 can be rotatably connected to the sliding bar 32. In the embodiment, the connecting member 342 and the limiting members 31 are connected to different positions of the handle 341. When the handle 341 is rotated, the handle 341 brings the connecting member 342 to rotate, and the connecting member 342 pulls/pushes the sliding bar 32 to slide. In other embodiments, the handle 341 can be fixed to the sliding bar 32. When the handle 341 is pushed/pulled, the handle 341 brings the sliding bar 32 to slide.

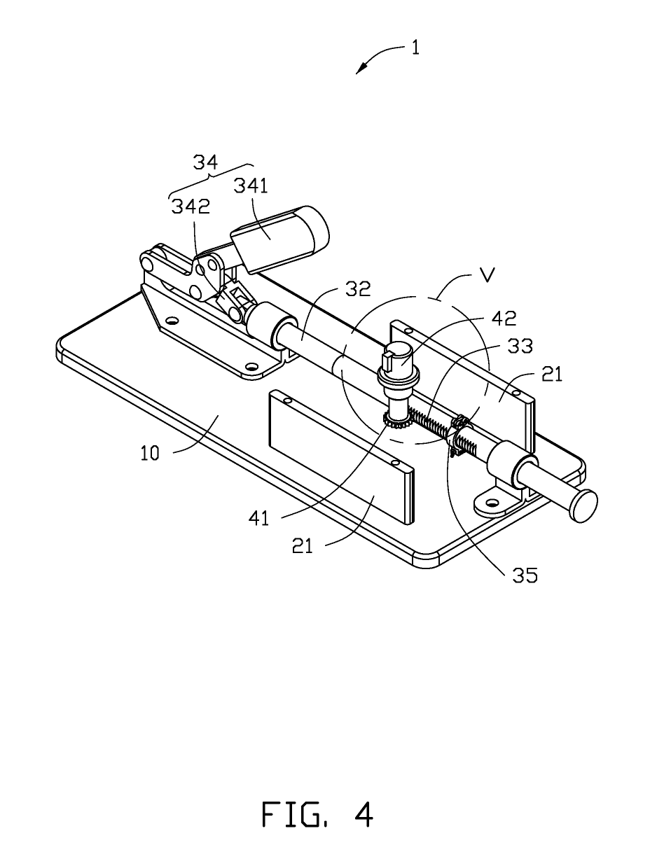

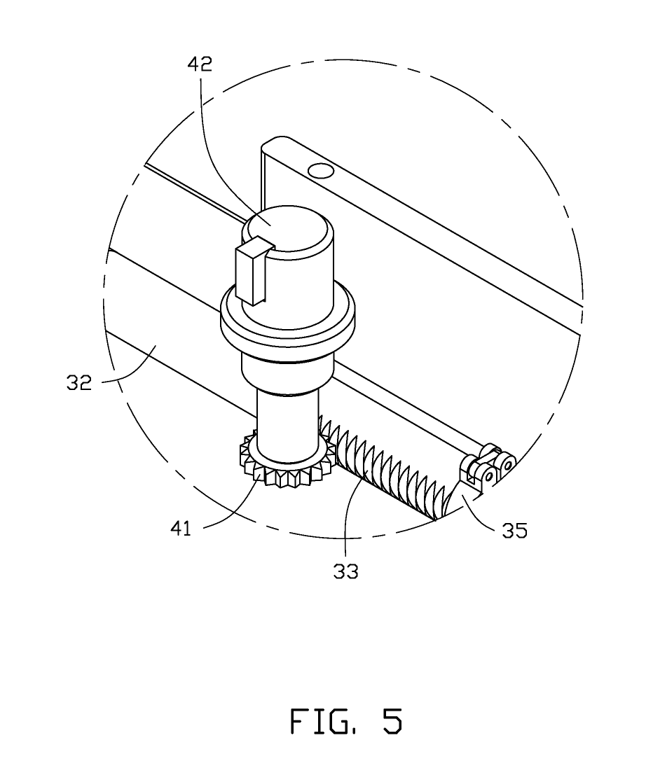

FIGS. 4-5 illustrate an engagement state of the rack 33 and the gear 41. In the embodiment, the sliding member 30 can further include at least one resisting ring 35. The sliding bar 32 can be fixed in a ring of the at least one resisting ring 35. The at least one resisting ring 35 prevents the gear 41 from rotating when the gear 41 resists the resisting ring 35. In the embodiment, the position of the resisting ring 35 on the sliding bar 32 can be adjustable, which causes the rotation angle of the gear 41 to be adjusted. Therefore, the rotation angle of the platform 43 is adjustable.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including, the full extent established by the broad general meaning of the terms used in the claims.

What is claimed is:

1. A rotatable assembly comprising:
a base;
a supporting member substantially perpendicularly protruding from the base;
a sliding member comprising a sliding bar and a rack, the sliding bar being slidably connected to the base and passing through the supporting member, the rack being fixed to the surface of the sliding bar; and
a rotatable member comprising a gear, a shaft, and a platform, the gear engaging with the rack, the shaft passing through the supporting member to rotatably connect to the supporting member, the shaft being fixed in a hollow of the gear and being fixed to the platform, and the platform being configured to arrange an electronic device thereon;
wherein when the sliding bar is driven to slide, the sliding bar brings the rack to slide, the gear engages with the rack to rotate the shaft, the platform rotates together with the shaft, rotating the electronic device arranged on the platform.

2. The rotatable assembly as described in claim 1, wherein the supporting member comprises two supporting plates, a top plate, and a bearing, the two supporting plates substantially perpendicularly protrude from the base and is spaced from each other, the top plate is fixed on one supporting plate, extends from the one supporting plate to the other supporting plate, and is fixed to the other supporting plate, the top plate, the supporting plates, and the base cooperatively form a receiving room, the top plate defines a first through hole from an upper surface to a lower surface, the bearing is fixed in the first through hole of the top plate, the shaft passing through a hollow of bearing to rotatably connect to the top plate.

3. The rotatable assembly as described in claim 2, wherein a bottom of the shaft is fixed in a hollow of the gear and a top of the shaft is fixed to the platform.

4. The rotatable assembly as described in claim 2, wherein the sliding member further comprises two limiting members, each limiting member is fixed to the base and is spaced from each other, each limiting member defines a second through hole, the sliding bar passes through the second through hole of each limiting member and extends through the receiving room.

5. The rotatable assembly as described in claim 1, wherein the rack extends along the length of the sliding bar.

6. The rotatable assembly as described in claim 1, wherein the sliding member further comprises an operating member, the operating member is movably connected to the base, the operating member exerts a force to the sliding bar to slide the sliding bar with respect to the base.

7. The rotatable assembly as described in claim 6, wherein the operating member comprises a handle and a connecting member, the handle is rotatably connected to one limiting member, a first end of the connecting member is rotatably connected to the handle and a second end of the connecting member is rotatably connected to the sliding bar.

8. The rotatable assembly as described in claim 7, wherein the connecting member and the limiting member are connected to different positions of the handle.

9. The rotatable assembly as described in claim 6, wherein the operating member comprises a handle, the handle is fixed to the sliding bar.

10. The rotatable assembly as described in claim 1, wherein the sliding member further comprises at least one resisting ring, the sliding bar is fixed in a ring of the at least one resisting ring and arranged at a position of the rack, the at least one resisting ring prevents the gear from rotating when the gear resists the resisting ring.

11. The rotatable assembly as described in claim 10, wherein the position of the at least one resisting ring is adjustable.
